(19) United States
(12) Patent Application Publication
(10) Pub. No.: US 2012/0200407 A1
(43) Pub. Date: Aug. 9, 2012

(54) METHODS, SYSTEMS, AND COMPUTER PROGRAM PRODUCTS FOR MANAGING ATTENTION OF AN OPERATOR AN AUTOMOTIVE VEHICLE

(76) Inventor: Robert Paul Morris, Raleigh, NC (US)

(21) Appl. No.: 13/023,952

(22) Filed: Feb. 9, 2011

(51) Int. Cl. B60Q 1/00

(52) U.S. Cl. 340/439

(57) ABSTRACT

Methods and systems are described for managing attention of an operator an automotive vehicle. An automotive vehicle having an operator for driving the automotive vehicle is detected. A determination is made the automotive vehicle is transporting a portable electronic device. A user interaction with the portable electronic device is detected during the transporting. Attention information is sent to an output device to present an attention output defined for directing the operator to attend to the driving, in response to detecting the user interaction.

### RELATED APPLICATIONS

This application is related to the following commonly owned U.S. patent applications, the entire disclosures being incorporated by reference herein: application Ser. No. ______, (Docket No 0075) filed on Aug. 2, 2011, entitled “Methods, Systems, and Program Products for Directing Attention of an Occupant of an Automotive Vehicle to a Viewport”;

application Ser. No. ______, (Docket No 0133) filed on Aug. 2, 2011, entitled “Methods, Systems, and Program Products for Directing Attention to a Sequence of Viewports of an Automotive Vehicle”; and

application Ser. No. ______, (Docket No 0170) filed on Aug. 8, 2011, entitled “Methods, Systems, and Program Products for Altering Attention of an Automotive Vehicle Operator”.

### BACKGROUND

Driving while distracted is a significant cause of highway accidents. Recent attention to the dangers of driving while talking on a phone and/or driving while “texting” have brought the public's attention to this problem. While the awareness is newly heightened the problem is quite old. Driving while eating, adjusting a car's audio system, and even talking to other passengers can and does take drivers' attention away from driving, thus creating and/or otherwise increasing risks.

A need exists to assist drivers in focusing their attention where it is needed to increase highway safety as well as a need for automotive vehicles to respond when a driver is not paying sufficient attention. Accordingly, there exists a need for methods, systems, and computer program products for managing attention of an operator an automotive vehicle.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Methods and systems are described for managing attention of an operator an automotive vehicle. In one aspect, the method includes detecting an automotive vehicle having an operator for driving the automotive vehicle. The method further includes determining that the automotive vehicle is transporting a portable electronic device. The method still further includes detecting, during the transporting, a user interaction with the portable electronic device. The method also includes sending attention information to present, via an output device, an attention output defined for directing the operator to attend to the driving, in response to detecting the user interaction.

Further, a system for managing attention of an operator an automotive vehicle is described. The system includes an vehicle monitor component, an device detector component, an attention monitor component, and an attention director component adapted for operation in an execution environment. The system includes the vehicle monitor component configured for detecting an automotive vehicle having an operator for driving the automotive vehicle. The system further includes the device detector component configured for determining that the automotive vehicle is transporting a portable electronic device. The system still further includes the attention monitor component configured for detecting, during the transporting, a user interaction with the portable electronic device. The system still further includes the attention director component configured for sending attention information to present, via an output device, an attention output defined for directing the operator to attend to the driving, in response to detecting the user interaction.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a block diagram illustrating an exemplary hardware device included in and/or otherwise providing an execution environment in which the subject matter may be implemented;

FIG. 2 is a flow diagram illustrating a method for managing attention of an operator an automotive vehicle according to an aspect of the subject matter described herein;

FIG. 3 is a block diagram illustrating an arrangement of components for managing attention of an operator an automotive vehicle according to another aspect of the subject matter described herein;

FIG. 4a is a block diagram illustrating an arrangement of components for managing attention of an operator an automotive vehicle according to another aspect of the subject matter described herein;

FIG. 4b is a block diagram illustrating an arrangement of components for managing attention of an operator an automotive vehicle according to another aspect of the subject matter described herein;

FIG. 5 is a network diagram illustrating an exemplary system for managing attention of an operator an automotive vehicle according to another aspect of the subject matter described herein; and

FIG. 6 is a diagram illustrating a user interface presented to an occupant of an automotive vehicle in another aspect of the subject matter described herein.

### DETAILED DESCRIPTION

One or more aspects of the disclosure are described with reference to the drawings, wherein like reference numerals are generally utilized to refer to like elements throughout, and wherein the various structures are not necessarily drawn to scale. In the following description, for purposes of explanation, numerous specific details are set forth in order to provide a thorough understanding of one or more aspects of the disclosure. It may be evident, however, to one skilled in the art, that one or more aspects of the disclosure may be practiced with a lesser degree of these specific details. In other instances, well-known structures and devices are shown in block diagram form in order to facilitate describing one or more aspects of the disclosure.

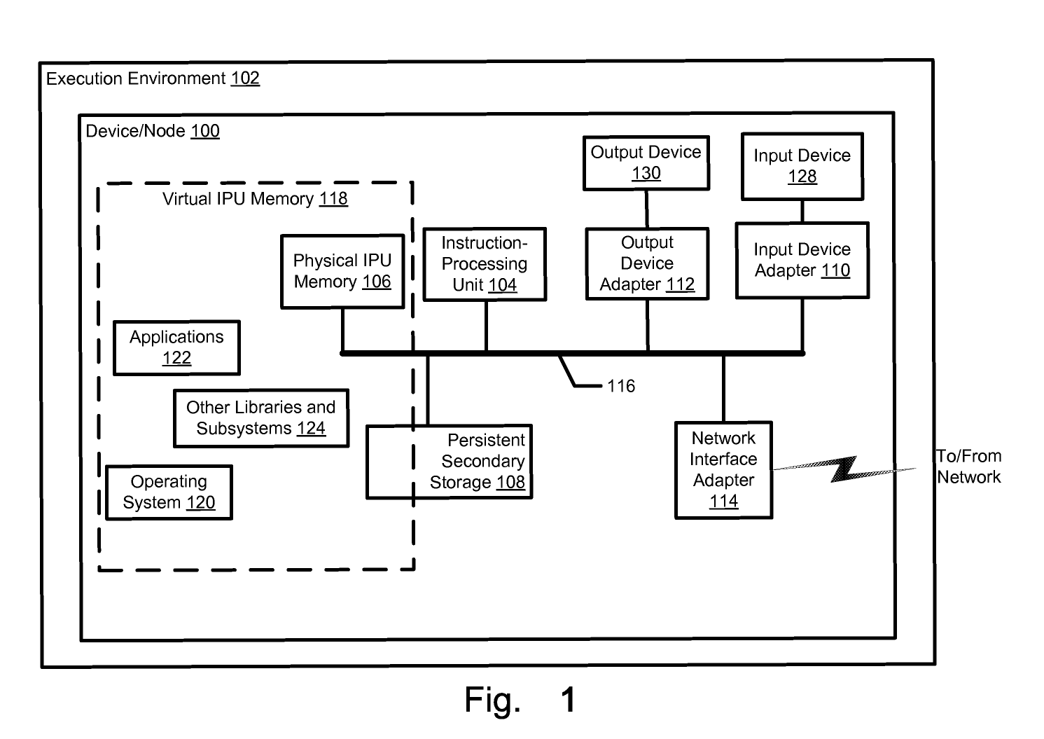

An exemplary device included in an execution environment that may be configured according to the subject matter is illustrated in FIG. 1. An execution environment includes an arrangement of hardware and, in some aspects, software that may be further configured to include an arrangement of components for performing a method of the subject matter described herein. An execution environment includes and/or is otherwise provided by one or more devices. An execution environment may include a virtual execution environment including software components operating in a host execution environment. Exemplary devices included in and/or otherwise providing suitable execution environments for configuring according to the subject matter include an automobile, a truck, a van, and/or sports utility vehicle. Alternatively or additionally a suitable execution environment may include and/or may be included in a personal computer, a notebook computer, a tablet computer, a server, a portable electronic device, a handheld electronic device, a mobile device, a multiprocessor device, a distributed system, a consumer electronic device, a router, a communication server, and/or any other suitable device. Those skilled in the art will understand that the components illustrated in FIG. 1 are exemplary and may vary by particular execution environment.

FIG. 1 illustrates hardware device 100 included in execution environment 102. FIG. 1 illustrates that execution environment 102 includes instruction-processing unit (IPU) 104, such as one or more microprocessors; physical IPU memory 106 including storage locations identified by addresses in a physical memory address space of IPU 104; persistent secondary storage 108, such as one or more hard drives and/or flash storage media; input device adapter 110, such as a key or keypad hardware, a keyboard adapter, and/or a mouse adapter; output device adapter 112, such as a display and/or an audio adapter for presenting information to a user; a network interface component, illustrated by network interface adapter 114, for communicating via a network such as a LAN and/or WAN; and a communication mechanism that couples elements 104-114, illustrated as bus 116. Elements 104-114 may be operatively coupled by various means. Bus 116 may comprise any type of bus architecture, including a memory bus, a peripheral bus, a local bus, and/or a switching fabric.

IPU 104 is an instruction execution machine, apparatus, or device. Exemplary IPUs include one or more microprocessors, digital signal processors (DSPs), graphics processing units, application-specific integrated circuits (ASICs), and/or field programmable gate arrays (FPGAs). In the description of the subject matter herein, the terms “IPU” and “processor” are used interchangeably. IPU 104 may access machine code instructions and data via one or more memory address spaces in addition to the physical memory address space. A memory address space includes addresses identifying locations in a processor memory. The addresses in a memory address space are included in defining a processor memory. IPU 104 may have more than one processor memory. Thus, IPU 104 may have more than one memory address space. IPU 104 may access a location in a processor memory by processing an address identifying the location. The processed address may be identified by an operand of a machine code instruction and/or may be identified by a register or other portion of IPU 104.

FIG. 1 illustrates virtual IPU memory 118 spanning at least part of physical IPU memory 106 and at least part of persistent secondary storage 108. Virtual memory addresses in a memory address space may be mapped to physical memory addresses identifying locations in physical IPU memory 106. An address space for identifying locations in a virtual processor memory is referred to as a virtual memory address space; its addresses are referred to as virtual memory addresses; and its IPU memory is referred to as a virtual IPU memory or virtual memory. The terms “IPU memory” and “processor memory” are used interchangeably herein. Processor memory may refer to physical processor memory, such as IPU memory 106, and/or may refer to virtual processor memory, such as virtual IPU memory 118, depending on the context in which the term is used.

Physical IPU memory 106 may include various types of memory technologies. Exemplary memory technologies include static random access memory (SRAM) and/or dynamic RAM (DRAM) including variants such as dual data rate synchronous DRAM (DDR SDRAM), error correcting code synchronous DRAM (ECC SDRAM), RAMBUS DRAM (RDRAM), and/or XDR™ DRAM. Physical IPU memory 106 may include volatile memory as illustrated in the previous sentence and/or may include nonvolatile memory such as nonvolatile flash RAM (NVRAM) and/or ROM.

Persistent secondary storage 108 may include one or more flash memory storage devices, one or more hard disk drives, one or more magnetic disk drives, and/or one or more optical disk drives. Persistent secondary storage may include a removable medium. The drives and their associated computer-readable storage media provide volatile and/or nonvolatile storage for computer-readable instructions, data structures, program components, and other data for execution environment 102.

Execution environment 102 may include software components stored in persistent secondary storage 108, in remote storage accessible via a network, and/or in a processor memory. FIG. 1 illustrates execution environment 102 including operating system 120, one or more applications 122, and other program code and/or data components illustrated by other libraries and subsystems 124. In an aspect, some or all software components may be stored in locations accessible to IPU 104 in a shared memory address space shared by the software components. The software components accessed via the shared memory address space are stored in a shared processor memory defined by the shared memory address space. In another aspect, a first software component may be stored in one or more locations accessed by IPU 104 in a first address space and a second software component may be stored in one or more locations accessed by IPU 104 in a second address space. The first software component is stored in a first processor memory defined by the first address space and the second software component is stored in a second processor memory defined by the second address space.

Software components typically include instructions executed by IPU 104 in a computing context referred to as a “process”. A process may include one or more “threads”. A “thread” includes a sequence of instructions executed by IPU 104 in a computing sub-context of a process. The terms “thread” and “process” may be used interchangeably herein when a process includes only one thread.

Execution environment 102 may receive user-provided information via one or more input devices illustrated by input device 128. Input device 128 provides input information to other components in execution environment 102 via input device adapter 110. Execution environment 102 may include an input device adapter for a keyboard, a touch screen, a microphone, a joystick, a television receiver, a video camera, a still camera, a document scanner, a fax, a phone, a modem, a network interface adapter, and/or a pointing device, to name a few exemplary input devices.

Input device 128 included in execution environment 102 may be included in device 100 as FIG. 1 illustrates or may be external (not shown) to device 100. Execution environment 102 may include one or more internal and/or external input devices. External input devices may be connected to device 100 via corresponding communication interfaces such as a serial port, a parallel port, and/or a universal serial bus (USB) port. Input device adapter 110 receives input and provides a representation to bus 116 to be received by IPU 104, physical IPU memory 106, and/or other components included in execution environment 102.

Output device 130 in FIG. 1 exemplifies one or more output devices that may be included in and/or that may be external to and operatively coupled to device 100. For example, output device 130 is illustrated connected to bus 116 via output device adapter 112. Output device 130 may be a display device. Exemplary display devices include liquid crystal displays (LCDs), light emitting diode (LED) displays, and projectors. Output device 130 presents output of execution environment 102 to one or more users. In some embodiments, an input device may also include an output device. Examples include a phone, a joystick, and/or a touch screen. In addition to various types of display devices, exemplary output devices include printers, speakers, tactile output devices such as motion-producing devices, and other output devices producing sensory information detectable by a user. Sensory information detected by a user is referred to as “sensory input” with respect to the user.

A device included in and/or otherwise providing an execution environment may operate in a networked environment communicating with one or more devices via one or more network interface components. The terms “communication interface component” and “network interface component” are used interchangeably herein. FIG. 1 illustrates network interface adapter (NIA) 114 as a network interface component included in execution environment 102 to operatively couple device 100 to a network. A network interface component includes a network interface hardware (NIH) component and optionally a software component.

Exemplary network interface components include network interface controller components, network interface cards, network interface adapters, and line cards. A node may include one or more network interface components to interoperate with a wired network and/or a wireless network. Exemplary wireless networks include a BLUETOOTH network, a wireless 802.11 network, and/or a wireless telephony network (e.g., a cellular, PCS, CDMA, and/or GSM network). Exemplary network interface components for wired networks include Ethernet adapters, Token-ring adapters, FDDI adapters, asynchronous transfer mode (ATM) adapters, and modems of various types. Exemplary wired and/or wireless networks include various types of LANs, WANs, and/or personal area networks (PANs). Exemplary networks also include intranets and internets such as the Internet.

The terms “network node” and “node” in this document both refer to a device having a network interface component for operatively coupling the device to a network. Further, the terms “device” and “node” used herein refer to one or more devices and nodes, respectively, providing and/or otherwise included in an execution environment unless clearly indicated otherwise.

The user-detectable outputs of a user interface are generically referred to herein as “user interface elements”. More specifically, visual outputs of a user interface are referred to herein as “visual interface elements”. A visual interface element may be a visual output of a graphical user interface (GUI). Exemplary visual interface elements include windows, textboxes, sliders, list boxes, drop-down lists, spinners, various types of menus, toolbars, ribbons, combo boxes, tree views, grid views, navigation tabs, scrollbars, labels, tooltips, text in various fonts, balloons, dialog boxes, and various types of button controls including check boxes and radio buttons. An application interface may include one or more of the elements listed. Those skilled in the art will understand that this list is not exhaustive. The terms “visual representation”, “visual output”, and “visual interface element” are used interchangeably in this document. Other types of user interface elements include audio outputs referred to as “audio interface elements”, tactile outputs referred to as “tactile interface elements”, and the like.

A visual output may be presented in a two-dimensional presentation where a location may be defined in a two-dimensional space having a vertical dimension and a horizontal dimension. A location in a horizontal dimension may be referenced according to an X-axis and a location in a vertical dimension may be referenced according to a Y-axis. In another aspect, a visual output may be presented in a three-dimensional presentation where a location may be defined in a three-dimensional space having a depth dimension in addition to a vertical dimension and a horizontal dimension. A location in a depth dimension may be identified according to a Z-axis. A visual output in a two-dimensional presentation may be presented as if a depth dimension existed allowing the visual output to overlie and/or underlie some or all of another visual output.

An order of visual outputs in a depth dimension is herein referred to as a “Z-order”. The term “Z-value” as used herein refers to a location in a Z-order. A Z-order specifies the front-to-back ordering of visual outputs in a presentation space. A visual output with a higher Z-value than another visual output may be defined to be on top of or closer to the front than the other visual output, in one aspect.

A “user interface (UI) element handler” component, as the term is used in this document, includes a component configured to send information representing a program entity for presenting a user-detectable representation of the program entity by an output device, such as a display. A “program entity” is an object included in and/or otherwise processed by an application or executable. The user-detectable representation is presented based on the sent information. Information that represents a program entity for presenting a user detectable representation of the program entity by an output device is referred to herein as “presentation information”. Presentation information may include and/or may otherwise identify data in one or more formats. Exemplary formats include image formats such as JPEG, video formats such as MP4, markup language data such as hypertext markup language (HTML) and other XML-based markup, a bit map, and/or instructions such as those defined by various script languages, byte code, and/or machine code. For example, a web page received by a browser from a remote application provider may include HTML, ECMAScript, and/or byte code for presenting one or more user interface elements included in a user interface of the remote application. Components configured to send information representing one or more program entities for presenting particular types of output by particular types of output devices include visual interface element handler components, audio interface element handler components, tactile interface element handler components, and the like.

A representation of a program entity may be stored and/or otherwise maintained in a presentation space. As used in this document, the term “presentation space” refers to a storage region allocated and/or otherwise provided for storing presentation information, which may include audio, visual, tactile, and/or other sensory data for presentation by and/or on an output device. For example, a buffer for storing an image and/or text string may be a presentation space. A presentation space may be physically and/or logically contiguous or non-contiguous. A presentation space may have a virtual as well as a physical representation. A presentation space may include a storage location in a processor memory, secondary storage, a memory of an output adapter device, and/or a storage medium of an output device. A screen of a display, for example, is a presentation space.

As used herein, the term “program” or “executable” refers to any data representation that may be translated into a set of machine code instructions and optionally associated program data. Thus, a program or executable may include an application, a shared or non-shared library, and/or a system command. Program representations other than machine code include object code, byte code, and source code. Object code includes a set of instructions and/or data elements that either are prepared for linking prior to loading or are loaded into an execution environment. When in an execution environment, object code may include references resolved by a linker and/or may include one or more unresolved references. The context in which this term is used will make clear that state of the object code when it is relevant. This definition can include machine code and virtual machine code, such as Java™ byte code.

As used herein, an “addressable entity” is a portion of a program, specifiable in programming language in source code. An addressable entity is addressable in a program component translated for a compatible execution environment from the source code. Examples of addressable entities include variables, constants, functions, subroutines, procedures, modules, methods, classes, objects, code blocks, and labeled instructions. A code block includes one or more instructions in a given scope specified in a programming language. An addressable entity may include a value. In some places in this document “addressable entity” refers to a value of an addressable entity. In these cases, the context will clearly indicate that the value is being referenced.

Addressable entities may be written in and/or translated to a number of different programming languages and/or representation languages, respectively. An addressable entity may be specified in and/or translated into source code, object code, machine code, byte code, and/or any intermediate languages for processing by an interpreter, compiler, linker, loader, and/or other analogous tool.

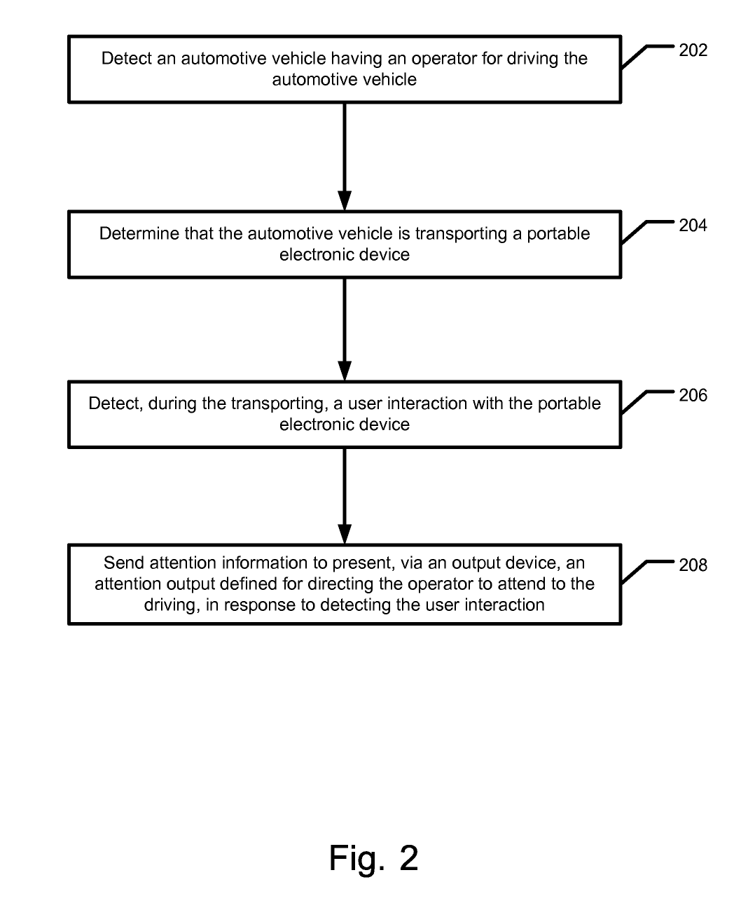

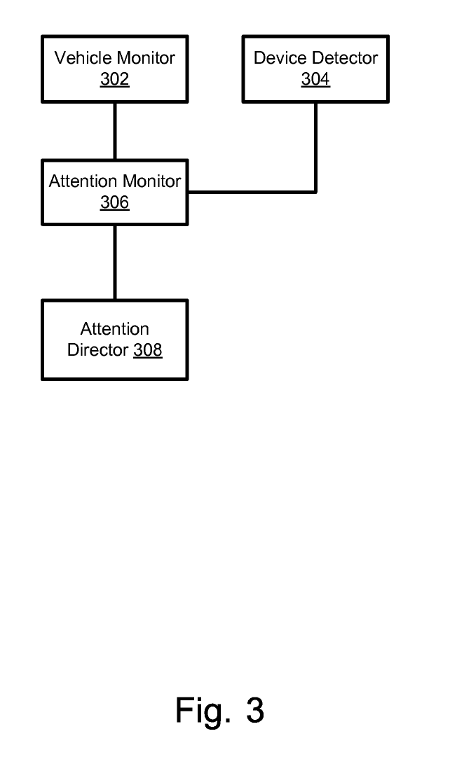

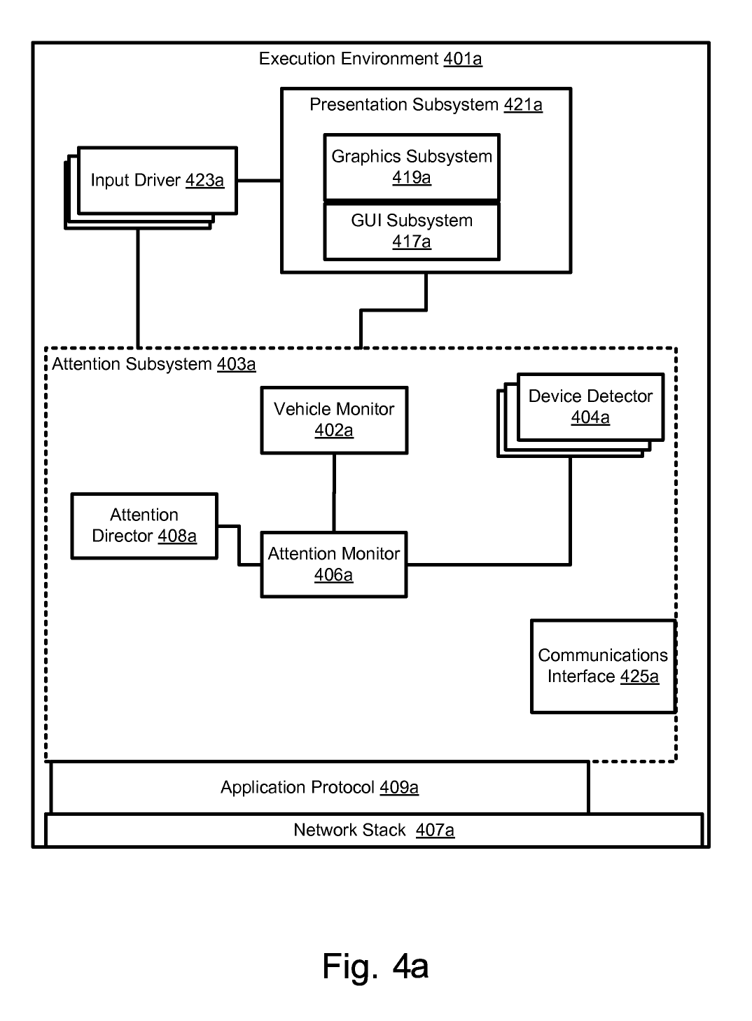

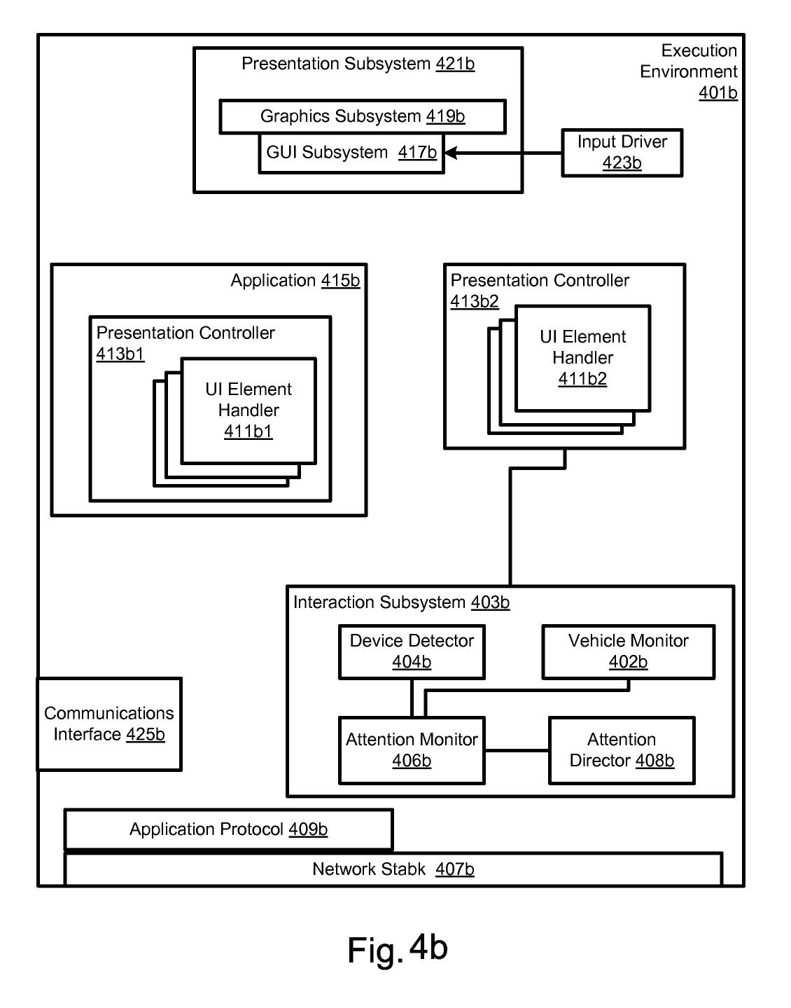

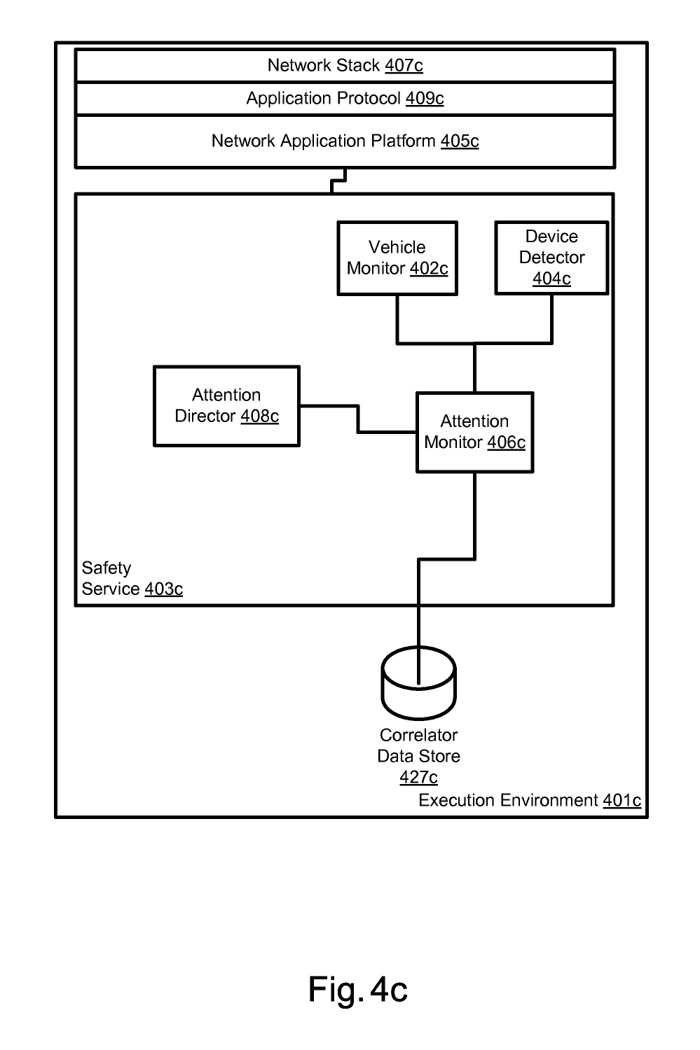

The block diagram in FIG. 3 illustrates an exemplary system for managing attention of an operator an automotive vehicle according to the method illustrated in FIG. 2. FIG. 3 illustrates a system, adapted for operation in an execution environment, such as execution environment 102 in FIG. 1, for performing the method illustrated in FIG. 2. The system illustrated includes a vehicle monitor component 302, a device detector component 304, an attention monitor component 306, and an attention director component 308. The execution environment includes an instruction-processing unit, such as IPU 104, for processing an instruction in at least one of the vehicle monitor component 302, the device detector component 304, the attention monitor component 306, and the attention director component 308. Some or all of the exemplary components illustrated in FIG. 3 may be adapted for performing the method illustrated in FIG. 2 in a number of execution environments. FIGS. 4a-c are each block diagrams illustrating the components of FIG. 3 and/or analogs of the components of FIG. 3 respectively adapted for operation in execution environment 401a, execution environment 401b, and execution environment 401c that include or that otherwise are provided by one or more nodes. Components, illustrated in FIG. 4a, FIG. 4b, and FIG. 4c, are identified by numbers with an alphabetic character postfix. Execution environments; such as execution environment 401a, execution environment 401b, execution environment 401c, and their adaptations and analogs; are referred to herein generically as execution environment 401 or execution environments 401 when describing more than one. Other components identified with an alphabetic postfix may be referred to generically or as a group in a similar manner.

FIG. 1 illustrates key components of an exemplary device that may at least partially provide and/or otherwise be included in an execution environment. The components illustrated in FIG. 4a, FIG. 4b, and FIG. 4c may be included in or otherwise combined with the components of FIG. 1 to create a variety of arrangements of components according to the subject matter described herein.

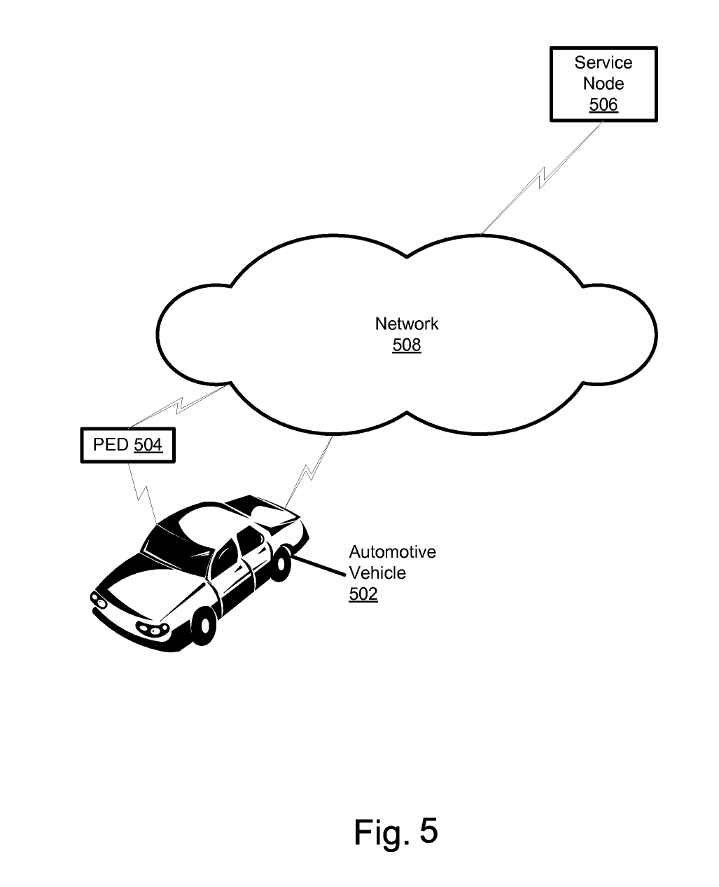

FIG. 4a illustrates an execution environment 401a including an adaptation of the arrangement of components in FIG. 3. In an aspect, execution environment 401a may be included in automotive vehicle 502 illustrated in FIG. 5. FIG. 4b illustrates an execution environment 401b including an adaptation of the arrangement in FIG. 3. In an aspect, execution environment 401b may be included in portable electronic device (PED) 504 illustrated in FIG. 5. As used herein, the term “portable electronic device” refers to a portable device including an IPU and configured to provide a user interface for interacting with a user. Exemplary portable electronic devices include mobile phones, tablet computing devices, personal media players, and media capture devices, to name a few examples. FIG. 5 illustrates PED 504 external to automotive vehicle 502 for ease of illustration. In many, if not most cases, a portable electronic device will be in an automotive vehicle, such as in a storage compartment, on a seat, held by an occupant of the automotive vehicle, in clothing of an occupant, and/or worn by an occupant. FIG. 4c illustrates an execution environment 401c configured to host a network accessible application illustrated by safety service 403c. Safety service 403c includes another adaptation or analog of the arrangement of components in FIG. 3. In an aspect, execution environment 401c may include and/or otherwise be provided by service node 506 illustrated in FIG. 5.

Adaptations and/or analogs of the components illustrated in FIG. 3 may be installed persistently in an execution environment while other adaptations and analogs may be retrieved and/or otherwise received as needed via a network. In an aspect, some or all of the arrangement of components operating in automotive vehicle 502 and/or in PED 504 may be received via network 508. For example, service node 506 may provide some or all of the components. Various adaptations of the arrangement in FIG. 3 may operate at least partially in execution environment 401a, at least partially in execution environment 401b, and/or at least partially in execution environment 401c. An arrangement of components for performing the method illustrated in FIG. 2 may operate in a single execution environment, in one aspect, and may be distributed across more than one execution environment, in another aspect.

As stated the various adaptations of the arrangement in FIG. 3 are not exhaustive. For example, those skilled in the art will see based on the description herein that arrangements of components for performing the method illustrated in FIG. 2 may be adapted to operate in an automotive vehicle, in a portable electronic device, in a node other than the automotive vehicle and other than the portable electronic device, and may be distributed across more than one node in a network and/or more than one execution environment.

As described above, FIG. 5 illustrates automotive vehicle 502. An automotive vehicle may include a gas powered, oil powered, bio-fuel powered, solar powered, hydrogen powered, and/or electricity powered car, truck, van, bus, and the like.

In an aspect, automotive vehicle 502 may communicate with one or more application providers via a network, illustrated by network 508 in FIG. 5. Service node 506 illustrates one such application provider. Automotive vehicle 502 may communicate with network application platform 405c in FIG. 4c operating in execution environment 401c included in and/or otherwise provided by service node 506 in FIG. 5. Automotive vehicle 502 and service node 506 may each include a network interface component operatively coupling each respective node to network 508.

In another aspect, PED 504 may communicate with one or more application providers. PED 504 may communicate with the same and/or different application provider as automotive vehicle 502. For example, PED 504 may communicate with network application platform 405c in FIG. 4c operating in service node 506. PED 504 and service node 506 may each include a network interface component operatively coupling each respective node to network 508.

In still another aspect, PED 504 may communicate with automotive vehicle 502. PED 504 and automotive vehicle 502 may communicate via network 508. Alternatively or additionally, PED 504 and automotive vehicle may 502 may communicate via a communications interface operatively coupled to a physical link between PED 504 and automotive vehicle 502. For example, PED 504 may operate as a peripheral device with respect to automotive vehicle 502 and/or vice versa. The communicative couplings described between and among automotive vehicle 502, PED 504, and service node 506 are exemplary and, thus, not exhaustive.

FIGS. 4a-c illustrate network stacks 407 configured for sending and receiving data over a network such as the Internet. Network application platform 405c in FIG. 4c may provide one or more services to safety service 403c. For example, network application platform 405c may include and/or otherwise provide web server functionally on behalf of safety service 403c. FIG. 4c also illustrates network application platform 405c configured for interoperating with network stack 407c providing network services for safety service 403c. Network stack 407a in FIG. 4a and network stack 407b in FIG. 4b serve roles analogous to network stack 407c.

Network stacks 407 may support the same protocol suite, such as TCP/IP, or may enable their hosting nodes to communicate via a network gateway (not shown) or other protocol translation device(s) (not shown) and/or service(s) (not shown). For example, automotive vehicle 502 and service node 506 in FIG. 5 may interoperate via their respective network stacks: network stack 407a in FIG. 4a and network stack 407c in FIG. 4c.

FIG. 4a illustrates attention subsystem 403a; FIG. 4b illustrates interaction subsystem 403b; and FIG. 4c illustrates safety service 403c. FIGS. 4a-c illustrate application protocol components 409 exemplifying components configured to communicate according to one or more application protocols. Exemplary application protocols include a hypertext transfer protocol (HTTP), a remote procedure call (RPC) protocol, an instant messaging, and/or a presence protocol. Application protocol components 409 in FIGS. 4a-c may support compatible application protocols. Matching protocols enable, for example, attention subsystem 403a, supported by automotive vehicle 502, to communicate with safety service 403c of service node 506 via network 508 in FIG. 5. Matching protocols are not required if communication is via a protocol gateway or other protocol translator.

In FIG. 4a, attention subsystem 403a may receive some or all of the arrangement of components in FIG. 4a in one more messages received via network 508 from another node. In an aspect, the one or more messages may be sent by safety service 403c via network application platform 405c, network stack 407c, a network interface component, and/or application protocol component 409c in execution environment 401c. Attention subsystem 403a may interoperate with one or more of the application protocols provided by application protocol component 409a and/or with network stack 407a to receive the message or messages including some or all of the components and/or their analogs adapted for operation in execution environment 401a.

In FIG. 4b, interaction subsystem 403b may receive some or all of the arrangement of components in FIG. 4b in one more messages received via network 508 from another node. In an aspect, the one or more messages may be sent by safety service 403c via network application platform 405c, network stack 407c, a network interface component, and/or application protocol component 409c in execution environment 401c. Interaction subsystem 403b may interoperate via one or more of the application protocols supported by application protocol component 409b and/or with network stack 407b to receive the message or messages including some or all of the components and/or their analogs adapted for operation in execution environment 401b.

UI element handler components 411b are illustrated in respective presentation controller components 413b in FIG. 4b. UI element handler components 411 and presentation controller components 413 are not shown in FIG. 4a and in FIG. 4c, but those skilled in the art will understand upon reading the description herein that adaptations and/or analogs of these components configured to perform analogous operations may be adapted for operating in execution environment 401a as well as execution environment 401c. A presentation controller component 413 may manage the visual, audio, and/or other types of output of an application or executable. FIG. 4b illustrates presentation controller component 413b1 including one or more UI element handler components 411b1 for managing one or more types of output for application 415b. A presentation controller component and/or a UI element handler component may be configured to receive and route detected user and other inputs to components and extensions of its including application or executable.

With respect to FIG. 4b, a UI element handler component 411b in various aspects may be adapted to operate at least partially in a content handler component (not shown) such as a text/html content handler component and/or a script content handler component. One or more content handlers may operate in an application such as a web browser. Additionally or alternatively, a UI element handler component 411 in an execution environment 401 may operate in and/or as an extension of its including application or executable. For example, a plug-in may provide a virtual machine, for a UI element handler component received as a script and/or byte code. The extension may operate in a thread and/or process of an application and/or may operate external to and interoperating with an application.

FIG. 4b illustrates application 415b operating in execution environment 401b included in PED 504. Various UI elements of application 415b may be presented by one or more UI element handler components 411b1 in FIG. 4b. Applications and/or other types of executable components operating in execution environment 401a and/or execution environment 403c may also include UI element handler components and/or otherwise interoperate with UI element handler components for presenting user interface elements via one or more output devices, in some aspects. FIG. 4b illustrates interaction subsystem operatively coupled to presentation controller component 413b2 and UI element handler components 411b2 for presenting output via one or more output devices of execution environment 401b.

GUI subsystems 417 illustrated respectively in FIG. 4a and in FIG. 4b may instruct a corresponding graphics subsystem 419 to draw a UI interface element in a region of a display presentation space, based on presentation information received from a corresponding UI element handler component 411. A graphics subsystem 419 and a GUI subsystem 417 may be included in a presentation subsystem 421 which may include one or more output devices and/or may otherwise be operatively coupled to one or more output devices.

In some aspects, input may be received and/or otherwise detected via one or more input drivers illustrated by input drivers 423 in FIGS. 4a-b. An input may correspond to a UI element presented via an output device. For example, a user may manipulate a pointing device, such as touch screen, to a pointer presented in a display presentation space over a user interface element, representing a selectable operation. A user may provide an input detected by an input driver 423. The detected input may be received by a GUI subsystem 417 via the input driver 423 as an operation or command indicator based on the association of the shared location of the pointer and the operation user interface element. FIG. 4a illustrates that an input driver 432a may receive information for a detected input and may provide information based on the input without presentation subsystem 421a operating as an intermediary. FIG. 4a illustrates, that in an aspect, one or more components in attention subsystem 403a may receive input information in response to an input detected by an input driver 423a.

An “interaction”, as the term is used herein, refers to any activity including a user and an object where the object is a source of sensory input detected by the user. In an interaction the user directs attention to the object. An interaction may also include the object as a target of input from the user. The input may be provided intentionally or unintentionally by the user. For example, a rock being held in the hand of a user is a target of input, both tactile and energy input, from the user. A portable electronic device is a type of object. In another example, a user looking at a portable electronic device is receiving sensory input from the portable electronic device whether the device is presenting an output via an output device or not. The user manipulating an input component of the portable electronic device exemplifies the device, as an input target, receiving input from the user. Note that the user in providing input is detecting sensory information from the portable electronic device provided that the user directs sufficient attention to be aware of the sensory information and provided that no disabilities prevent the user from processing the sensory information. An interaction may include an input from the user that is detected and/or otherwise sensed by the device. An interaction may include sensory information that is detected by a user included in the interaction and presented by an output device included in the interaction.

As used herein “interaction information” refers to any information that identifies an interaction and/or otherwise provides data about an interaction between the user and an object, such as a personal electronic device. Exemplary interaction information may identify a user input for the object, a user-detectable output presented by an output device of the object, a user-detectable attribute of the object, an operation performed by the object in response to a user, an operation performed by the object to present and/or otherwise produce a user-detectable output, and/or a measure of interaction.

Interaction information for one object may include and/or otherwise identify interaction information for another object. For example, a motion detector may detect an operator's head turn in the direction of a windshield of an automobile. Interaction information identifying the operator's head is facing the windshield may be received and/or used as interaction information for the windshield indicating the operator's is receiving visual input from a viewport provided by some or all of the windshield. The interaction information may serve to indicate a lack of operator interaction with one or more other viewports such as a rear window of the automotive vehicle. Thus the interaction information may serve as interaction information for one or more viewports.

The term “occupant” as used herein refers to a passenger of an automotive vehicle. An operator of an automotive vehicle is an occupant of the automotive vehicle. As the terms are used herein, an “operator” of an automotive vehicle and a “driver” of an automotive vehicle are equivalent.

Vehicle information may include and/or otherwise may identify any information about an automotive vehicle for determining whether an automotive vehicle is operating. Analogously, device information is any information about a personal electronic device for detecting an interaction between a user and the personal electronic device. For example, vehicle information for an automotive vehicle may include and/or otherwise identify a speed, a rate of acceleration, a thermal property of an operational component, a change in distance to an entity external to the vehicle, an input of an operator detected by the automotive vehicle, and the like. Exemplary device information may identify a detected user input, a user detectable output, an operation performed in response to a user input, and/or an operation perform to present a user detectable output. The term “device user”, as used herein, refers to a user of a device. The term “operational component”, as used herein, refers to a component of a device included in the operation of a device. A viewport is one type of operational component of an automotive vehicle.

The term “viewport” as used herein refers to any opening and/or surface of an automobile that provides a view of a space outside the automotive vehicle. A window, a screen of a display device, a projection from a projection device, and a mirror are all viewports and/or otherwise included in a viewport. A view provided by a viewport may include an object external to the automotive vehicle visible to the operator and/other occupant. The external object may be an external portion of the automotive vehicle or may be an object that is not part of the automotive vehicle.

With reference to FIG. 2, block 202 illustrates that the method includes detecting an automotive vehicle having an operator for driving the automotive vehicle. Accordingly, a system for managing attention of an operator an automotive vehicle includes means for detecting an automotive vehicle having an operator for driving the automotive vehicle. For example, as illustrated in FIG. 3, vehicle monitor component 302 is configured for detecting an automotive vehicle having an operator for driving the automotive vehicle. FIGS. 4a-c illustrate vehicle monitor components 402 as adaptations and/or analogs of vehicle monitor component 302 in FIG. 3. One or more vehicle monitor components 402 operate in an execution environment 401.

In FIG. 4a, vehicle monitor component 402a is illustrated as a component of attention subsystem 403a. In FIG. 4b, vehicle monitor component 402b is illustrated as a component of interaction subsystem 403b. In FIG. 4c, vehicle monitor component 402b is illustrated as a component of safety service 403c. A vehicle monitor component 402 may be adapted to receive vehicle information in any suitable manner, in various aspects. For example receiving vehicle information may include receiving a message via network, receiving data via a communications interface, detecting a user input, sending a message via a network, receiving data in response to data sent via a communications interface, receiving data via user interaction with a presented a user interface element, interoperating with an invocation mechanism, interoperating with an interprocess communication (IPC) mechanism, accessing a register of a hardware component, receiving data in response to generating a hardware interrupt, responding to a hardware interrupt, receiving data in response to generating a software interrupt, and/or responding to a software interrupt.

Exemplary invocation mechanisms include a function call, a method call, and a subroutine call. An invocation mechanism may pass data to and/or from a vehicle monitor component 402 via a stack frame and/or via a register of an IPU. Exemplary IPC mechanisms include a pipe, a semaphore, a signal, a shared data area, a hardware interrupt, and a software interrupt.

In an aspect, illustrated in FIG. 4a, vehicle monitor component 402a may receive vehicle information via an invocation in response to an operator input detected by an input driver component 423a interoperating with an input device adapter, as described with respect to FIG. 1. For example, a key may be detected when inserted into an ignition switch in automotive vehicle 502. The key may be configured for initiating operation of vehicle 502. An ignition or initiation subsystem (not shown) of vehicle 502 may send operating information identifying a state and/or operation performed by the initiation subsystem. Vehicle monitor component 402a may be activated by the initiation subsystem, in response to insertion of the key. Vehicle monitor component 402a may detect the operating of the initiation subsystem based on the activating of the vehicle monitor component 402a.

Vehicle information may be received in response detecting an ignition operation of an engine in the automotive vehicle, such detecting an insertion of a key, an alternator turn, power flow from a battery, and/or fuel flow to an engine. In another aspect, vehicle information may be received in response to detecting a motion of an operational component of the automotive vehicle such as a turn of a steering wheel and/or a shift in a transmission. In still another aspect, vehicle information may be received in response detecting a measure of heat of a component of the automotive vehicle; a speed of the automotive vehicle; an acceleration; a deceleration; a change in direction of motion of the automotive vehicle; a change in a measure of at least one of mass, inertia, centrifugal force, air pressure, friction, and weight; a change in location of the automotive vehicle; a change in a road surface in contact with the automotive vehicle; and/or an electromagnetic signal and/or sound wave.

In various configurations of an automotive vehicle 502, one or more of various operational components of respective automotive vehicles may be configured to provide operational information to a vehicle monitor component 402a. Exemplary operational components include a braking subsystem, a transmission subsystem, a steering subsystem, a fuel subsystem, an electrical subsystem, a cooling subsystem, an engine, an exhaust subsystem, a power train subsystem, and components of the various exemplary subsystems. An operational subsystem and/or operational component may include a sensor and/or monitor for determining and/or otherwise identifying an operation and/or operational state. Interoperation with a vehicle monitor component may be direct and/or indirect via any of the exemplary mechanisms described above and the like.

In another aspect, illustrated in FIG. 4b, vehicle monitor component 402b may receive vehicle information in a message received via network stack 407b and optionally via application protocol component 409b. In an aspect, PED 504 may request vehicle information via a network such as a local area network including automotive vehicle 502 and PED 504. PED 504 may listen for a heartbeat message on the LAN indicating automotive vehicle 502 is included as a node in the LAN. Interaction subsystem 403b may interoperate with a network interface adapter and/or network stack 407b to activate listening for the heartbeat message. Vehicle monitor component 402b may be configured to detect the operation of automotive vehicle 502 in response to detecting the heartbeat message. Alternatively or additionally, in response to detecting the heartbeat message, interaction subsystem 403b may invoke vehicle monitor component 402b to send a request to automotive vehicle 502 based on information in the heartbeat message. Vehicle information may be included in and/or otherwise identified in a response received by vehicle monitor component 402b.

Alternatively or additionally, vehicle monitor component 402b may receive vehicle information via communications interface 425b communicatively linking PED 504 with automotive vehicle 502. For example, PED 504 may be operatively coupled to automotive vehicle 502 via a universal serial bus (USB) component (not shown) included in and/or otherwise coupled to communications interface component 425b. Communications interface component 425b in PED 504, in an aspect, may detect a link to automotive vehicle 502 based on a USB profile active in the operative coupling. Vehicle information may be sent to PED 504 for receiving by vehicle monitor component 402b with and/or without a request sent from PED 504, according to the configuration of the particular arrangement of components.

Receiving vehicle information may include receiving the vehicle information via a physical communications link, a wireless network, a local area network (LAN), a wide area network (WAN), and/or an internet. Vehicle information may be received via any suitable communications protocol, in various aspects. Exemplary protocols include a universal serial bus (USB) protocol, a BLUETOOTH protocol, a TCP/IP protocol, hypertext transfer protocol (HTTP), a remote procedure call (RPC) protocol, a protocol supported by a serial link, a protocol supported by a parallel link, and Ethernet. Receiving vehicle information may include receiving a response to a request previously sent via a communications interface. Receiving vehicle information may include receiving the vehicle information in data transmitted asynchronously. An asynchronous message is not a response to any particular request and may be received without any associated previously transmitted request.

In yet another aspect, illustrated in FIG. 4c, network application platform component 405c may receive vehicle information in a message transmitted via network 508. The message may be routed within execution environment 401c to vehicle monitor component 402c by network application platform 405c. For example, the message may include a universal resource identifier (URI) that network application platform 405c is configured to associate with vehicle monitor component 402c. In an aspect, in response to an ignition event and/or an input from an operator of automotive vehicle 502, automotive vehicle 502 may send vehicle information to service node 506 via network 508. In another aspect, safety service 403c may be configured to monitor one or more automotive vehicles including automotive vehicle 502. A component of safety service 403c, such as vehicle monitor component 402c, may periodically send a message via network 508 to automotive vehicle 502 requesting vehicle information. If automotive vehicle is operating and is operatively coupled to network 508, automotive vehicle 502 may respond to the request by sending a message including vehicle information. The message may be received and the vehicle information may be provided to vehicle monitor component 402c as described above and/or in an analogous manner.

Block 204, in FIG. 2, illustrates that the method further includes determining that the automotive vehicle is transporting a portable electronic device. Accordingly, a system for managing attention of an operator an automotive vehicle includes means for determining that the automotive vehicle is transporting a portable electronic device. For example, as illustrated in FIG. 3, device detector component 304 is configured for determining that the automotive vehicle is transporting a portable electronic device. FIGS. 4a-c illustrate device detector components 404 as adaptations and/or analogs of device detector component 304 in FIG. 3. One or more device detector components 404 operate in execution environments 401.

In FIG. 4a, device detector component 404a is illustrated as a component of attention subsystem 403a. In FIG. 4b, device detector component 404b is illustrated as a component of interaction subsystem 403b. In FIG. 4c, device detector component 404c is illustrated as component of safety service 403c.

Device detector components 404 illustrated in FIG. 4-c may be adapted to receive device information in any suitable manner, in various aspects. For example receiving device information may include receiving a message via network, receiving data via a communications interface, detecting a user input, sending a message via a network, sending data via a communications interface, presenting a user interface element for interacting with a user, interoperating with an invocation mechanism, interoperating with an interprocess communication (IPC) mechanism, accessing a register of a hardware component, generating a hardware interrupt, responding to a hardware interrupt, generating a software interrupt, and/or responding to a software interrupt.

In an aspect, illustrated in FIG. 4b, device detector component 404b may receive device information via a hardware interrupt in response to insertion of a smart card in a smart card reader in and/or operatively attached to PED 504. In another aspect, input driver(s) 423b may detect user input from a button or sequence of buttons in PED 504. The button or buttons may receive input for an application accessible in and/or otherwise via PED 504, and/or for a hardware component in and/or accessible via PED 504. The input may be associated with a particular user of PED 504 by device detector component 404b which may include and/or otherwise may be configured to operate with an authentication component (not shown). The authentication component may operate, at least in part, in a remote node, such as service node 506. User ID and/or password information may be stored in persistent storage accessible within and/or via execution environment 401b. For example, user ID and password information may be stored in a data storage device of service node 506.

In another aspect, illustrated in FIG. 4a, device detector component 404a operating in automotive vehicle 502 may receive device information in a message received via network stack 407a and optionally via application protocol component 409a. Automotive vehicle 502 may receive the message asynchronously or in response to a request to PED 504. Attention subsystem 403a may interoperate with a network interface adapter and/or network stack 407a to receive the message. In response to receiving the message, attention subsystem 403a may send the device information via a message queue to be received by device detector component 404a which may be monitoring the message queue.

Alternatively or additionally, device detector component 404a may receive device information via communications interface 425a communicatively linking PED 504 with automotive vehicle 502. In an aspect, PED 504 may be operatively coupled to a serial port included in and/or otherwise coupled to communications interface component 425a. The serial port in automotive vehicle 502, in an aspect, may detect a link to PED 504 based on a signal received from PED 504 via the serial link. Device information may be sent to automotive vehicle 502 for receiving by device detector component 404a in response to a request from automotive vehicle 502.

Receiving device information may include receiving the device information via a physical communications link, a wireless network, a local area network (LAN), a wide area network (WAN), and an internet. Device information may be received via any suitable communications protocol, in various aspects. Exemplary protocols includes a universal serial bus (USB) protocol, a BLUETOOTH protocol, a TCP/IP protocol, hypertext transfer protocol (HTTP), a remote procedure call (RPC) protocol, a serial protocol, Ethernet, and/or a parallel port protocol. Receiving device information may include receiving a response to a request previously sent via communications interface. Receiving device information may include receiving the device information in data transmitted asynchronously.

In yet another aspect, illustrated in FIG. 4c, network application platform component 405c may receive device information in a message transmitted via network 508. The message and/or message content may be routed within execution environment 401c to device detector component 404c for receiving device information in and/or otherwise identified by the message sent from PED 504. The device information may be provided to device detector component 404c by network application platform 405c. For example, the message may be received via a Web or cloud application protocol interface (API) transported according to HTTP. The message may identify a particular service provided, at least in part, by device detector component 404c. In still another aspect, a message identifying device information may be received by device detector component 404c in service node 506 where the message is sent by automotive vehicle 502. Automotive vehicle 502 may receive the information from PED 504 identifying the device information prior to automotive vehicle 502 sending the message to service node 506.

In an aspect, in response to detecting an incoming communication identifying an interaction between the user of PED 504 as a communicant in the communication, PED 504 may send device information to service node 506 via network 508. The term “communicant”, as used herein, refers to a user participant in a communication.

In another aspect, safety service 403c may be configured to monitor one or more personal electronic devices including PED 504. A component of safety service 403c, such as device detector component 404c may periodically send a message via network 508 to PED 504 requesting device information. PED 504 may respond to the request by sending a message including device information. The message may be received and the device information may be provided to device detector component 404c as described above and/or in an analogous manner.

Returning to FIG. 2, block 206 illustrates that the method yet further includes detecting, during the transporting, a user interaction with the portable electronic device. Accordingly, a system for managing attention of an operator an automotive vehicle includes means for detecting, during the transporting, a user interaction with the portable electronic device. For example, as illustrated in FIG. 3, attention monitor component 306 is configured for detecting, during the transporting, a user interaction with the portable electronic device. FIGS. 4a-c illustrate attention monitor component 406b as adaptations and/or analogs of attention monitor component 306 in FIG. 3. One or more attention monitor components 406b operate in execution environments 401.

Detecting that a user is interacting with a portable electronic device may include detecting any interaction. In other aspects, an attention monitor component 406 may be configured to identify and/or otherwise detect a type of interaction; an attribute of data exchanged in the interaction; an application included in the interaction, an instruction processed based on the interaction; a state of the portable electronic device and/or a portion thereof; a pattern of inputs and/or outputs included in the interaction; a length of the interaction measured in time, data, energy, and/or any other suitable measure; and/or any attribute of the interaction that may affect and/or identify an attribute of an interaction of an operator with an operational component of an automotive vehicle. Matching information, a policy, and/or other configuration data may be provided to an attention monitor component 406 to configure the attention monitor component 406 to detect a user interaction with a portable electronic device.

In an aspect, detecting a user interaction between a user and a portable electronic device may include determining that the device user is the operator of an automotive vehicle detected as operating based on received vehicle information. Detecting that the operator of automotive vehicle 502 is the user of PED 504 may include an attention monitor component 406 performing and/or otherwise initiating a match operation based on received vehicle information and received device information. In an aspect, an attention monitor component 406 may determine whether a direct match exists between some or all the data in the vehicle information and the device information. For example, attention monitor component 406c operating in service node 506 may compare user IDs respectively identified in vehicle information received, directly and/or indirectly, from automotive vehicle 502 and in device information received, directly and/or indirectly, from PED 504.

In another aspect, a match may be determined indirectly. Detecting that an operator of an automotive vehicle is a user of a portable electronic device may include detecting a first association identifying device information and a correlator. The detecting may further include locating and/or otherwise identifying a second association identifying vehicle information and the correlator. The first association and the second association both identifying the same correlator may be defined as an indication that the operator is the user.

In FIG. 4c, attention monitor component 406c may be invoked to locate a record in correlator data store 427c. A search for the record may be initiated based on information identified in vehicle information received for automotive vehicle 502. Attention monitor component 406c may also locate a record in correlator data store 427c based on information identified in device information received for PED 504. Attention monitor component 406c may further determine that the correlators identified in the respective records are the same correlator and/or determine that the correlators are equivalents. Attention monitor component 406c may be configured to identify the operator of automotive vehicle 502 as the user of PED 504 when the device information and the vehicle information have matching correlators. The personal identity of the user and/or operator need not be revealed in the communication and may not be required in detecting that the operator is the user.

A correlator may be included in device information and/or associated with a device via a record that identifies the correlator and some or all of the information identified by the device information. As with the device information, a correlator may be in vehicle information and/or otherwise identified by an association identifying the correlator and some or all of the information in the vehicle information.

A correlator may be generated from and/or otherwise based on device information and/or vehicle information. Rather than or in addition to looking up a stored correlator, attention monitor components 406 in FIGS. 4a-c may be configured to generate a correlator by, for example, calculating a value from one or more user communications addresses identified in one or more of the device information for PED 504 and the vehicle information for automotive vehicle 502.

In another aspect, detecting a user interaction with a portable electronic device while an automotive vehicle is operating may include determining that the automotive vehicle and the portable electronic device are communicatively coupled via a particular a communications interface, a particular network port, and/or a particular protocol. Detecting the interaction during operating of the automotive vehicle may be based on one or more of the communications interface, the network port, and the protocol. For example, communications interface component 425b may be configured to communicate via a protocol defined for indicating that PED 504 communicating via communications interface component is operating and/or more particularly that PED 504 is included in an interaction with a user. Attention monitor component 406b may interoperate with communications interface component 425b to detect when PED 504 successfully communicates with automotive vehicle 502 via the defined protocol. Attention monitor component 406b may be configured to detect user interaction with PED 504 while automotive vehicle 502 is operating in response to detecting the successful communication. In an aspect, no personal information about the user and/or the operator need be communicated via the defined protocol. A successful communication via the particular protocol may be defined to be sufficient for an attention monitor component 406 to detect an interaction between the user and PED 504 while automotive vehicle 502 is operating.

In another aspect, an attention monitor component 406 may operate to detect a user interaction with PED 504, during operating of automotive vehicle 502, in response to receiving device information and vehicle information. In another aspect, an attention monitor component 406 may be configured to detect a user interaction with a portable electronic device in response to some other condition and/or event. For example, detecting whether a user interaction with a portable electronic device may be performed in response to detecting a request, processed by the portable electronic device, for a communication with another node where the user of the portable electronic device is identified as a communicant.

For example, detecting a user interaction with PED 504 during operating of automotive vehicle 502 may be performed in response to detecting an operation to process a voice communication, an email, a short message service (SMS) communication, a multi-media message service (MMS) communication, an instant message communication, and/or a video message communication, where the user of PED 504 is identified as a communicant in the detected communication(s). Execution environment 401b may include a communications client (not shown), such as a text messaging client, that represents the user, identified by a communications address, as a communicant in text messages sent by PED 504 and/or received by PED 504 on behalf of the user.

A communication may be detected in response to an input from the user of PED 504 to initiate a communication session, send data in a communication, and/or to receive data in a communication. Alternatively or additionally, a communication may be detected in response to receiving a message from a node, via network 508, where the node includes a communications client that represents another communicant included in and/or otherwise represented in the communication.

Returning to FIG. 2, block 208 illustrates that the method yet further includes sending attention information to present, via an output device, an attention output defined for directing the operator to attend to the driving, in response to detecting the user interaction. Accordingly, a system for managing attention of an operator an automotive vehicle includes means for sending attention information to present, via an output device, an attention output defined for directing the operator to attend to the driving, in response to detecting the user interaction. For example, as illustrated in FIG. 3, attention director component 308 is configured for sending attention information to present, via an output device, an attention output defined for directing the operator to attend to the driving, in response to detecting the user interaction. FIGS. 4a-c illustrate attention director component 408 as adaptations and/or analogs of attention director component 308 in FIG. 3. One or more attention director components 408 operate in execution environments 401.

In various aspects, attention director component 308 in FIG. 3 and its adaptations, as illustrated in FIGS. 4a-c, may be configured to send attention information in any suitable manner. For example, sending attention information may include receiving a message via network, receiving data via a communications interface, detecting a user input, sending a message via a network, receiving data in response to data sent via a communications interface, receiving data via user interaction with a presented user interface element, interoperating with an invocation mechanism, interoperating with an interprocess communication (IPC) mechanism, accessing a register of a hardware component, receiving data in response to generating a hardware interrupt, responding to a hardware interrupt, receiving data in response to generating a software interrupt, and/or responding to a software interrupt.

In FIG. 4a, attention director component 408a may interoperate with presentation subsystem 421a, directly and/or indirectly, to send attention information including presentation information to an output device to present an attention output. The attention output may be presented to the operator of automotive vehicle 502 to alter a direction of, object of, and/or other attribute of attention for the operator for operating automotive vehicle 502. For example, an attention output may attract, instruct, and/or otherwise direct attention from the operator of automotive vehicle 502 to a viewport of automotive vehicle 502 based on attention information. Presentation subsystem 421a may be operatively coupled, directly and/or indirectly, to a display, a light, an audio device, a device that moves, and the like such as seat vibrator, a device that emits heat, a cooling device, a device that emits an electrical current, a device that emits an odor, and/or another output device that presents an output that may be sensed by the operator.

The term “attention output” as used herein refers to a user-detectable output to attract, instruct, and/or otherwise direct the attention of an operator of an automotive vehicle to interact and/or otherwise change an interaction with one or more operational component of the automotive vehicle. An operational component may be a particular viewport, a braking control mechanism, a steering control mechanism, and the like, as described above.

In FIG. 4b, attention director component 408b may send attention information to UI element handler component 411b2 for presenting an attention output to the user of PED 504 to instruct the operator, of automotive vehicle 502, to direct attention and/or otherwise change an attribute of the operator's attention to driving automotive vehicle 502. The user of PED 504 may be the operator of automotive 502. The UI element handler component 411b2 may invoke presentation controller 413b2 to interoperate with an output device via presentation subsystem 421b, as described above, to present the attention output. Presentation controller 413b2 may be operatively coupled, directly and/or indirectly, to a display, a light, an audio device, a device that moves, and the like.

An attention output may be represented by one or more attributes of a user interface element(s) that represent one or more operational components. For example, an attention director component 408 may be configured to send color information to present a color on a surface, such as display screen, of automotive vehicle 502 and/or PED 504. The color may be presented in a UI element representing a viewport of automotive vehicle 502 to direct attention of the operator to a view provided by the viewport. A first color may identify a higher attention output with respect to a lesser attention output based on a second color. For example, red may be defined as higher priority than orange, yellow, and/or green.

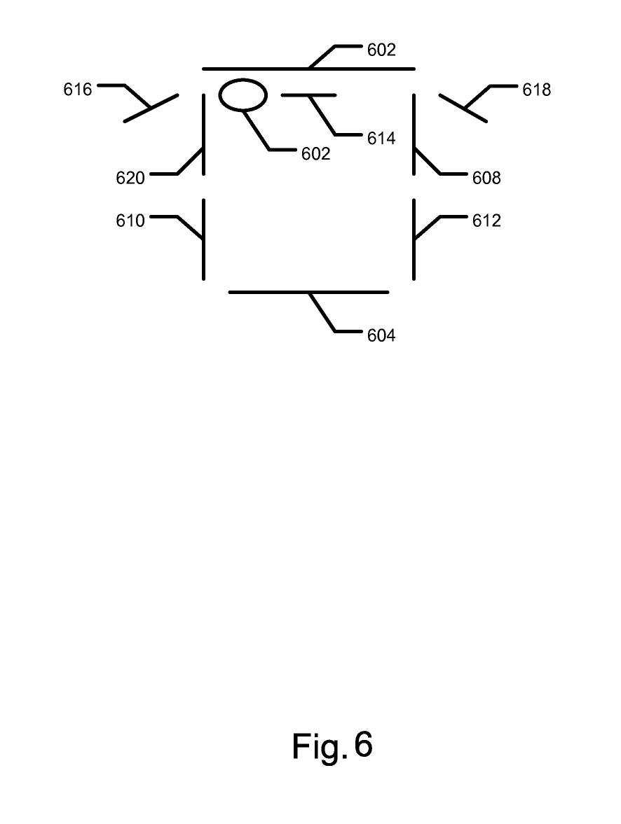

FIG. 6 illustrates user interface elements representing operational components to an operator and/or another occupant of an automotive vehicle. The operational components represented in FIG. 6 are viewports. The viewports are represented in FIG. 6 by respective line segment user interface elements. The presentation in FIG. 6 may be presented on a display in a dashboard, on a sun visor, in a window, and/or on any suitable surface of an automotive vehicle 502. FIG. 6 illustrates front indicator 602 representing a viewport including a windshield of the automotive vehicle 502, rear indicator 604 representing a viewport including a rear window, front-left indicator 606 representing a viewport including a corresponding window when closed or at least partially open, front-right indicator 608 representing a viewport including a front-right window, back-left indicator 610 representing a viewport including a back-left window, back-right indicator 612 representing a viewport including a back-right window, rear-view display indicator 614 representing a viewport including a rear-view mirror and/or a display device, left-side display indicator 616 representing a viewport including a left-side mirror and/or display device, right-side display indicator 618 representing a viewport including a right-side mirror and/or display device, and display indicator 620 representing a viewport including a display device in and/or on a surface of automotive vehicle 502. The user interface elements in FIG. 6 may be presented via the display device represented by display indicator 620 in the dashboard and/or as a heads up view presented in and/or on the front windshield.

Attention information representing an attention output for a viewport may include information for changing a border thickness in a border in a user interface element in and/or surrounding some or all of an operational component of automotive vehicle 502 and/or a surface of the operational component. For example, to attract attention to a view provided by the front-left mirror of automotive vehicle 502, attention director component 408a may send attention information to presentation controller 413a to present front-left indicator 616 with a thickness that is defined to indicate to the operator of automotive vehicle 502 to alter the operator's direction of attention to look at and/or pay closer attention to the left-side mirror and/or to alter the operator's level of attention to an object visible via the left-side mirror. A border thickness may be an attention output and a thickness and/or thickness relative to another attention output may identify an attention output as a higher attention output or a lesser attention output.

A visual pattern may be presented via a display device. The pattern may direct attention and/or otherwise alter an attribute of attention of the operator of automotive vehicle 502 to the current speed and/or direction of automotive vehicle 502 in response to attention information indicating a user interaction with PED 504. In an aspect, a sensor in PED 504 may have detected the operator, as user of PED 504, gazing at a display of PED 504.

In an aspect, attention director component 408c in service node 506 may send a message including attention information, via network 508 to automotive vehicle 502. Alternatively or additionally, an attention director component 408b operating in PED 504 may send attention information to automotive vehicle 502 to present an attention output to the operator of automotive vehicle 502.

In another aspect, a light in automotive vehicle 502 and/or a sound emitted by an audio device in automotive vehicle 502 may be defined to correspond to an operational component such as brake, a gauge, a dial, a turn signal control, a cruise control input mechanism, and the like. The light may be turned on to attract the attention of the operator to the brake to slow automotive vehicle 502 and/or the sound may be output for the same and/or a different operational component. In another aspect, the light may identify the brake as a higher priority operational component with respect to another operational component without a corresponding light or other attention output.

In yet another aspect, attention information may be sent to end an attention output. For example, the light and/or a sound may be turned off and/or stopped to alter the direction, object of, and/or level of attention of the operator.

An attention output to alter an attribute of attention of an operator may provide relative attention information as described above. In an aspect, attention outputs may be presented based on a multi-point scale providing relative indications of a need for an operator's attention. Higher priority or lesser priority may be identified based on the points on a particular scale. A multipoint scale may be presented based on text such as a numeric indicator and/or may be graphical, based on a size or a length of the indicator corresponding to a priority ordering.

For example, a first attention output may present a first number, based on device information for PED 504, to an operator of automotive vehicle 502. A second attention output may include a second number for another operational component. A number may be presented to alter a direction, level, and/or other attribute of attention of the operator. The size of the numbers may indicate a ranking or priority. For example, if the first number is higher than the second number, the scale may be defined to indicate to the operator's attention should be directed to an operational component associated with the first number instead of and/or before directing attention another operational component associated with the second number.

A user interface element, including an attention output, may be presented by a library routine of, for example, GUI subsystem 417b. Attention director component 408b may change a user-detectable attribute of the UI element. Alternatively or additionally, attention director component 408b in PED 504 may send attention information via network 508 to automotive vehicle 502 for presenting via an output device of automotive vehicle 502. An attention output may include information for presenting a new user interface element and/or to change an attribute of an existing user interface element to alter an attribute of attention of an operator.

A region of a surface in automotive vehicle 502 may be designated for presenting an attention output. As described above a region of a surface of automotive vehicle 502 may include a screen of a display device for presenting the user interface elements illustrated in FIG. 6. A position on and/or in a surface of automotive vehicle 502 may be defined for presenting an attention output for a particular operational component identified by and/or with the position. In FIG. 6, each user interface element has a position relative to the other indicators. The relative positions define respective viewports. A portion of a screen in a display device may be configured for presenting one or more attention outputs.

An attention director component 408 in FIG. 4a, in FIG. 4b, and/or in FIG. 4c may provide an attention output that indicates how soon an operational component of automotive vehicle 502 requires attention and/or a change in attention from the operator. Thus, attention information may include temporal information. For example, changes in size, location, and/or color may indicate whether an operational component requires attention, may give an indication of how soon an operational component may need attention, and/or may indicate a level of attention suggested and/or required. A time indication for attention may give an actual time and/or a relative indication may be presented.

In FIG. 4c, attention director component 408c in safety service 403c may send information via a response to a request and/or via an asynchronous message to a client, such as attention subsystem 403a and/or may exchange data with one or more input and/or output devices in one or both of automotive vehicles 502 and PED 504, directly and/or indirectly, to receive attention information and/or to send attention information. Attention director component 408c may send attention information in a message via network 508 to automotive vehicle 502 and/or to PED 504 for presenting via an output device.

Presentation subsystem 421a in FIG. 4a may be operatively coupled to a projection device for projecting a user interface element as and/or including an attention output on a windshield of automotive vehicle 502 to alter an attribute of attention of the operator. An attention output may be included in and/or may include one or more of an audio interface element, a tactile interface element, a visual interface element, and an olfactory interface element.

Attention information may include time information identifying a duration for presenting an attention output to maintain the attention of an operator. For example, PED 504 may be performing an operation where no user interaction is required for a time period. An attention output may be presented by attention director component 408b and/or by attention director component 408a in FIG. 4a for maintaining the attention of the operator of automotive vehicle 502 to one or more operational components based on the time period of no required interaction between the user and PED 504.

A user-detectable attribute and/or element of an attention output may be defined to identify and/or instruct an operator to alter an attribute of the operator's attention. For example, in FIG. 6 each line segment is defined to identify a particular operational component. A user-detectable attribute may include one or more of a location, a pattern, a color, a volume, a measure of brightness, and a duration of the presentation. A location may be one or more of in front of, in, and behind a surface of the automotive vehicle in which a operational component is visible. A location may be adjacent to an operational component and/or otherwise in a specified location relative to a corresponding operational component. An attention output may include a message including one or more of text data and voice data.

In still another aspect, attention information may be sent when it is determined that the operator is an owner of the vehicle and/or that the user is an owner of the portable electronic device. The attention information may be sent in response to determining one or more of the ownership relationships exist between the operator and automotive vehicle 502, and the device user and PED 504. Determining that an operator and/or user is an owner may be included in detecting whether the operator is the user. An attention monitor component 406 may be configured to determine whether an ownership relationship exists. Detecting that an operator and/or user is an owner may be included in sending attention information apart from determining that the owner is the user. An attention director component 408 may be configured to determine whether an ownership relationship exists, in another aspect.

Attention information may be sent to direct an operator to attend to driving an automotive vehicle by altering a constraint for an operation for one or more of accelerating, controlling speed, braking, turning, providing light, signaling another operator of another vehicle, presenting information to the operator of the automotive vehicle, providing power to an engine and/or other component, changing an ambient condition in a compartment of the automotive vehicle, operating a window wiper, operating a mirror, operating an media player, operating a navigation system, operating a steering control system, operating a seat, operating a heater, operating a transmission system, a operating tire pressure system, altering an aerodynamic attribute of the automotive vehicle, operating a window, operating a door, and operating a lid of a compartment.

In an aspect, a touch screen of a mobile device, such as mobile phone and/or tablet computing device, in automotive vehicle 502 may detect a touch input. The operator of automotive vehicle 502 may be logged into the mobile device. The mobile device may include a network interface component such as an 802.11 wireless adapter and/or a BLUETOOTH® adapter. The device may send input information to safety service 403c in service node 506 via network 508 and/or may send input information to attention subsystem 403a in FIG. 4a via a personal area network (PAN) and/or a wired connection to automotive vehicle 502. In response to the input identifying a user interaction with PED 504, attention director component 408c and/or attention director component 408b may send attention information to direct attention of the operator to operating automotive vehicle 502.

The method illustrated in FIG. 2 may include additional aspects supported by various adaptations and/or analogs of the arrangement of components in FIG. 3. For example, in various aspects, receiving vehicle information and/or receiving device information may include receiving a message as a response to a request in a previously sent message as described above. In addition, as described above, receiving vehicle information and/or receiving device information may include receiving a message transmitted asynchronously.

Vehicle information may identify an interaction with an operational component of an automotive vehicle based on an operation performed by an automotive vehicle. The operation may be performed in response to an input received by the automotive vehicle from the operator. For example, a vehicle monitor component 402 in FIGS. 4a-c may receive vehicle information, in response to an input by an operator to instruct automotive vehicle 502 to accelerate. In another example, an operation may be identified based on a button press sequence by an operator.

Vehicle information and/or device information may include, identify, and/or otherwise be based on one or more of a personal identification number (PIN), a hardware user identifier, an execution environment user identifier, an application user identifier, a password, a digital signature that may be included in a digital certificate, a user communications address of a communicant in a communication, a network address (e.g. a MAC address and/or an IP address), device identifier, a manufacturer identifier, a serial number, a model number, an ignition key, a detected start event, a removable data storage medium, a particular communications interface included in communicatively coupling the automotive vehicle and the portable electronic device, an ambient condition, geospatial information for the automotive vehicle, the operator, the user, and/or the portable electronic device, another occupant of the automotive vehicle, another portable electronic device, a velocity of the automotive vehicle, an acceleration of the automotive vehicle, a topographic attribute of a route of the automotive vehicle, a count of occupants in the automotive vehicle, a measure of sound, a measure of attention of at least one of the operator and the user, an attribute of another automotive vehicle, and an operational attribute of the automotive vehicle (e.g. tire pressure, weight, centrifugal force, and/or deceleration). Detecting a user interaction with a portable electronic device during an operating period of an automotive vehicle may be performed in response to receiving and/or otherwise based on one or more of the elements listed in the previous sentence.

In an aspect, a user interaction with a portable electronic device during an operating period of an automotive vehicle may be detected during specified times, such as after dark, identified by temporal information. Sending attention information may be performed in response to determining the operator has been interacting with PED 504 for a specified period of time identified in received interaction information. Detecting a user interaction with a portable electronic device during an operating period of an automotive vehicle may be performed only for certain devices and/or device types, in some aspects. One or more of the elements of the method illustrated in FIG. 2 may be performed only under particular ambient conditions, such as rain or snow that require a more attentive operator. An operator's driving experience, physical, and/or mental capabilities and/or limitations may affect when one or more of the elements in the method are performed. Any object or interaction that may affect the amount of attention needed from an operator to operate an automotive vehicle may affect when some or all of the method illustrated in FIG. 2 is performed in various aspects of the arrangement in FIG. 3. For example, some or all of the method may be performed in response to the presence of a child as an occupant of an automotive vehicle.

Vehicle information and/or device information may be received in response to detecting one or more of a request to perform a particular operation, a performing of a particular operation, wherein the operation is to be performed and/or is being performed by the automotive vehicle and/or the portable electronic device.

One or more of vehicle information and device information may be received by one or more of an automotive vehicle, a portable electronic device, and another node, where the other node is communicatively-coupled, directly and/or indirectly, to at least one of the automotive vehicle and the portable electronic device. Vehicle information may be received, via a network, by the portable electronic device and/or the other node. Device information may be received, via the network, by the automotive vehicle and the other node.

Detecting a user interaction with a portable electronic device during an operating period of an automotive vehicle may be based on one or more of a personal identification number (PIN), a hardware user identifier, an execution environment user identifier, an application user identifier, password, a digital signature that may be included in a digital certificate, a user communications address, a network address, device identifier, a manufacturer identifier, a serial number, a model number, a ignition key, a detected start event, a removable data storage medium, a particular communications interface included in communicatively coupling the automotive vehicle and the portable electronic device, temporal information, an ambient condition, geospatial information for the automotive vehicle, the operator, the user, the portable electronic device, another occupant of the automotive vehicle, a velocity of the automotive vehicle, an acceleration of the automotive vehicle, a topographic attribute of a route of the automotive vehicle, a count of occupants in the automotive vehicle, a measure of sound, a measure of attention of at least one of the operator and the user, an attribute of another automotive vehicle, and an operational attribute of the automotive vehicle.

As described above, detecting a user interaction with a portable electronic device during an operating period of an automotive vehicle and/or attention information may be sent in response to input detected by a sensor that may be integrated into an automotive vehicle or into a portable electronic device, such as a mobile phone and/or a media player that is in the automotive vehicle but not part of the automotive vehicle. The sensor may detect one or more of an eyelid position, an eyelid movement, an eye position, an eye movement, a head position, a head movement, a substance generated by at least a portion of a body of the occupant, a measure of verbal activity, a substance taken in bodily by the occupant. For example, interaction information may be received based on input detected by sensor such as a breathalyzer device that may identify and/or that may be included in determining a measure of visual attention based on blood-alcohol information included in and/or identified by the interaction information.

Detecting a user interaction with a portable electronic device during a period of operating of an automotive vehicle may include receiving a message, via a communications interface, identifying interaction information for the portable electronic device. The user interaction may be detected based on receiving the message. The message may be sent without identifying device information and/or vehicle information. The message may be received by one or more of the automotive vehicle and by node that is not the portable electronic device and is not part of the automotive vehicle, according to some aspects. The node may be personal electronic device communicatively coupled to the portable electronic device. The message may be included in a communication between a first communicant represented by the portable electronic device and a second communicant represented by another electronic device. One or more of the communicants are identified by a communications identifier.

Exemplary communication addresses include a phone identifier (e.g. a phone number), an email address, an instant message address, a short message service (SMS) address, a multi-media message service (MMS) address, an instant message address, a presence tuple identifier, and a video user communications address. A user communications address may be identified by an alias associated with the user communications address. For example, a user communications address may be located in an address book entry identified via an alias. An alias may be another user communications address for the user.

Exemplary operations for which attention information may be sent, in response, include one or more of presenting output to the user, receiving input from the user, receiving a message included in a communication including the user as a communicant, and sending a message included in a communication including the user a communicant.

One or more of detecting a user interaction with a portable electronic device during an operating period of an automotive vehicle and sending attention information may be performed in response to and/or otherwise based on one or more of an attribute of the occupant, a count of occupants in the automotive vehicle, an attribute of the automotive vehicle, an attribute of an object in a location including the automotive vehicle, a speed of the automotive vehicle, a direction of movement of an occupant and/or an automotive vehicle, a movement of a steering mechanism of an automotive vehicle, an ambient condition, a topographic attribute of a location including the automotive vehicle, a road, information from a sensor external to the automotive vehicle, and information from a sensor included in the automotive vehicle. For example, attention director 408a operating in automotive vehicle 502 may determine whether to send attention information based on a location of automotive vehicle 502. The attention information may be sent based on a classification of the topography of the location, in another aspect.

Attention information may be specified based on an attribute of a data entity, such as a data entity's content type. For example, attention information may be provided based on, for example, one or more MIME types identifying content types includable in navigation information. Attention information may identify a content type with a MIME type identifier, a file extension, a content type key included in a data entity, a detectable data structure in a data entity, and a source of a data entity. Exemplary sources that may be identified include nodes accessible via network, a folder in a file system, an application, a data storage device, a type of data such as an executable file, and a data storage medium.

Alternatively or additionally, attention information may be specified based on an identifier of an executable, a process, a thread, a hardware component identifier, a location in a data storage medium, a software component, a universal resource identifier (URI), a MIME type, an attribute of a user interaction included in performing the operation, a network address, a protocol, a communications interface, a content handler component, and a command line. An identifier of an attribute of a user interaction may be based on a type of user sensory activity. A user sensory activity may include at least one of visual activity, tactile activity, and auditory activity. In still another aspect, an identifier of an attribute of a user interaction may be identified based on an input device and/or an output device included in the user interaction.

The method illustrated in FIG. 2 may further include detecting an event defined for ending the presenting of the attention output. Additional attention information may be sent to stop the presenting of the attention output by the output device.

In an aspect, an output device for presenting an attention output may be operatively coupled to at least one of the portable electronic device and the automotive vehicle. Attention information for presenting an attention output may be sent to a device other than the automotive vehicle and other than the portable electronic device for presenting the attention output by an output device.

To the accomplishment of the foregoing and related ends, the descriptions and annexed drawings set forth certain illustrative aspects and implementations of the disclosure. These are indicative of but a few of the various ways in which one or more aspects of the disclosure may be employed. The other aspects, advantages, and novel features of the disclosure will become apparent from the detailed description included herein when considered in conjunction with the annexed drawings.

It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components may be added while still achieving the functionality described herein. Thus, the subject matter described herein may be embodied in many different variations, and all such variations are contemplated to be within the scope of what is claimed.

To facilitate an understanding of the subject matter described above, many aspects are described in terms of sequences of actions that may be performed by elements of a computer system. For example, it will be recognized that the various actions may be performed by specialized circuits or circuitry (e.g., discrete logic gates interconnected to perform a specialized function), by program instructions being executed by one or more instruction-processing units, or by a combination of both. The description herein of any sequence of actions is not intended to imply that the specific order described for performing that sequence must be followed.

Moreover, the methods described herein may be embodied in executable instructions stored in a computer readable medium for use by or in connection with an instruction execution machine, system, apparatus, or device, such as a computer-based or processor-containing machine, system, apparatus, or device. As used herein, a “computer readable medium” may include one or more of any suitable media for storing the executable instructions of a computer program in one or more of a portable electronic, magnetic, optical, electromagnetic, and infrared form, such that the instruction execution machine, system, apparatus, or device may read (or fetch) the instructions from the computer readable medium and execute the instructions for carrying out the described methods. A non-exhaustive list of conventional exemplary computer readable media includes a portable computer diskette; a random access memory (RAM); a read only memory (ROM); an erasable programmable read only memory (EPROM or Flash memory); and optical storage devices, including a portable compact disc (CD), a portable digital video disc (DVD), a high definition DVD (HD-DVD™), and a Blu-ray™ disc; and the like.

Thus, the subject matter described herein may be embodied in many different forms, and all such forms are contemplated to be within the scope of what is claimed. It will be understood that various details may be changed without departing from the scope of the claimed subject matter. Furthermore, the foregoing description is for the purpose of illustration only, and not for the purpose of limitation, as the scope of protection sought is defined by the claims as set forth hereinafter together with any equivalents.

All methods described herein may be performed in any order unless otherwise indicated herein explicitly or by context. The use of the terms “a” and “an” and “the” and similar referents in the context of the foregoing description and in the context of the following claims are to be construed to include the singular and the plural, unless otherwise indicated herein explicitly or clearly contradicted by context. The foregoing description is not to be interpreted as indicating that any non-claimed element is essential to the practice of the subject matter as claimed.

I claim:

1. A method for managing attention of an operator an automotive vehicle, the method comprising:
detecting an automotive vehicle having an operator for driving the automotive vehicle;
determining that the automotive vehicle is transporting a portable electronic device;
detecting, during the transporting, a user interaction with the portable electronic device; and
sending attention information to present, via an output device, an attention output defined for directing the operator to attend to the driving, in response to detecting the user interaction.

2. The method of claim 1 wherein the further comprises: at least one of receiving vehicle information about the automotive vehicle and receiving device information about the portable electronic device.

3. The method of claim 2 wherein the vehicle information, based on an operation performed by the vehicle in response to an input received by the automotive vehicle from the operator, indicates the automotive vehicle is operating while the user interaction is detected.

4. The method of claim 2 wherein at least one of the vehicle information and the device information is based on at least one of a personal identification number (PIN), a hardware user identifier, an execution environment user identifier, an application user identifier, a password, a digital signature, a vehicle identification number (VIN), a communications address, a network address, device identifier, a manufacturer identifier, a serial number, a model number, an ignition key, a detected start event, a removable data storage medium, a particular communications interface communicatively included in communicatively coupling the automotive vehicle and the portable electronic device, temporal information, an ambient condition, geospatial information, another occupant of the automotive vehicle, another portable electronic device, a velocity of the automotive vehicle, an acceleration of the automotive vehicle, a topographic attribute or a route of the automotive vehicle, a count of occupants in the automotive vehicle, a measure of sound, a measure of attention of at least one of the operator and the user, an attribute of another automotive vehicle, and an operational attribute of the automotive vehicle.

5. The method of claim 5 wherein the communications address includes at least one of a phone address (phone number), an email address, an instant message address, a short message service (SMS) address, a multi-media message service (MMS) address, an instant message address, a presence tuple identifier, and a video communications address.

6. The method of claim 2 wherein at least one of the vehicle information and the device information is received in response to a detecting of at least one of a request to perform and a performing of a particular operation by at least one of the automotive vehicle and the portable electronic device.

7. The method of claim 2 wherein the user interaction is detected based on receiving the device information.

8. The method of claim 1 wherein detecting the user interaction includes receiving a message, via a communications interface, identifying interaction information for the portable electronic device; and detecting the user interaction in response to receiving the message.

9. The method of claim 8 wherein the message is received by at least one of the automotive vehicle, and by node that is not the portable electronic device and is not part of the automotive vehicle.

10. The method of claim 8 wherein the node is communicatively coupled to the portable electronic device.

11. The method of claim 10 wherein the message is included in a communication between a first communicant and a second communicant, wherein the first communicant is represented by the portable electronic device.

12. The method of claim 11 wherein the communication includes at least one of an email, a voice message, image data, a short message service (SMS) message, a multimedia message service (MMS) message, an instant message, and presence data.

13. The method of claim 1 further comprises: determining that a user included in the user interaction is the operator; and sending the attention information in response to determining the operator is the user.

14. The method of claim 1 wherein the attention information includes temporal information identifying a duration for presenting the attention output.

15. The method of claim 1 wherein a user detectable attribute of the attention output is defined to identify an operational component included in operating the automotive vehicle to the operator.

16. The method of claim 1 wherein the method further comprises: detecting an event defined for ending the presenting of the attention output; and sending additional attention information to stop the presenting of the attention output by the output device.

17. The method of claim 1 wherein the output device is at least one of included in and operatively coupled to at least one of the portable electronic device and the automotive vehicle

18. The method of claim 1 wherein the attention information is sent to a device other than the automotive vehicle and other than the portable electronic device for presenting the attention output via the output device.

19. A system for managing attention of an operator an automotive vehicle, the system comprising:
a vehicle monitor component, a device detector component, and an attention monitor component, and an attention director component adapted for operation in an execution environment;
the vehicle monitor component configured for detecting an automotive vehicle having an operator for driving the automotive vehicle;
the device detector component configured for determining that the automotive vehicle is transporting a portable electronic device;
the attention monitor component configured for detecting, during the transporting, a user interaction with the portable electronic device; and
the attention director component configured for sending attention information to present, via an output device, an attention output defined for directing the operator to attend to the driving, in response to detecting the user interaction

20. A computer-readable medium embodying a computer program, executable by a machine, for managing attention of an operator an automotive vehicle, the computer program comprising executable instructions for:
detecting an automotive vehicle having an operator for driving the automotive vehicle;
determining that the automotive vehicle is transporting a portable electronic device;
detecting, during the transporting, a user interaction with the portable electronic device; and
sending attention information to present, via an output device, an attention output defined for directing the operator to attend to the driving, in response to detecting the user interaction.
